(19) United States
(12) Patent Application Publication
(10) Pub. No.: US 2011/0071888 A1
(43) Pub. Date: Mar. 24, 2011

(54) OUTDOOR ADVERTISMENT DEVICE AND METHOD

(75) Inventors: Jae Hun CHOI, Daejeon (KR); Soo Jun PARK, Seoul (KR); Seon Hee PARK, Daejeon (KR)

(73) Assignee: Electronics and Telecommunications Research Institute, Daejeon (KR)

(21) Appl. No.: 12/860,532

(22) Filed: Aug. 20, 2010

(30) Foreign Application Priority Data
Sep. 22, 2009 (KR) 10-2009-0089510

(51) Int. Cl. G06Q 30/00

(52) U.S. Cl. 705/14.5

(57) ABSTRACT

Provided is a an outdoor advertisement device including an outdoor display part including an environment sensor and displaying transmitted advertisement data, and a control server for receiving a detection signal from the environment sensor, selecting the advertisement data corresponding to the current environment of a place at which the outdoor display part is installed, and transmitting the advertisement data to the outdoor display part. Therefore, an advertisement can be selected according to peripheral environmental information using sensors installed at the outdoor advertisement device to perform advertisement, increasing attention of passersby, utility of the advertisement, and thus increasing advertisement effect.

### CROSS-REFERENCE TO RELATED APPLICATION

This application claims the benefit of Korean Patent Application No. 10-2009-0089510, filed Sep. 22, 2009, the disclosure of which is hereby incorporated herein by reference in its entirety.

### BACKGROUND

1. Field of the Invention

The present invention relates to an outdoor advertisement device and method, and more particularly, to an outdoor advertisement device and method capable of selective advertisement according to environment around the outdoor advertisement device.

2. Discussion of Related Art

In general, large-sized outdoor advertisement devices such as large-sized electronic displays, etc., are installed at buildings or squares. Such outdoor advertisement devices are useful advertisement means for informing passersby of news, advertisements, etc.

In particular, when the large-sized outdoor advertisement devices are used for advertisement in densely populated areas or places having large floating populations, the effect of the advertisement increases.

Such outdoor advertisement devices register specific programs and repeatedly display preset advertisements.

However, since the outdoor advertisement devices repeatedly display the preset advertisements, regardless of peripheral environment that vary from moment to moment, the outdoor advertisement devices cannot excite curiosity of advertisement viewers, decreasing utility thereof.

### SUMMARY OF THE INVENTION

The present invention is directed to an outdoor advertisement device and method capable of actively adapting to variation in peripheral environment.

According to one aspect of the present invention, an outdoor advertisement device includes: an outdoor display part including an environment sensor and displaying transmitted advertisement data; and a control server for receiving a detection signal from the environment sensor, selecting the advertisement data corresponding to the current environment of a place at which the outdoor display part is installed, and transmitting the advertisement data to the outdoor display part.

The environment sensor may generate the detection signal of information about temperature, humidity, weather, population density, floating population, or floating vehicles in the place at which the outdoor display part is installed.

The outdoor advertisement device may further include an internet server for transmitting preference information of the advertisement data.

The control server may determine order of priority of the advertisement data according to the detection signal and the preference information of the advertisement data.

The control server may include: a database in which the advertisement data are classified and recorded; a communication part in communication with the outdoor display part and the internet server; and a controller for receiving the detection signal from the communication part, receiving the preference information from the internet server, and selecting the advertisement data of the outdoor display part from the database.

The controller may select the advertisement data on the basis of the detection signal and time information.

The advertisement data may be received from the internet server to be recorded in the database.

The outdoor display part may be a liquid crystal display (LCD), a light emitting diode (LED), or a plasma display panel (PDP).

According to another aspect of the present invention, an outdoor advertisement method includes: receiving a detection signal of current environmental information of a place at which an outdoor display part is installed from an environment sensor of the outdoor display part; selecting advertisement data corresponding to the detection signal; receiving preference information of the selected advertisement data from an internet server; determining order of priority of the advertisement data according to the preference information; and displaying the advertisement data on the outdoor display part according to the preference data.

The environment sensor may generate the detection signal of information about temperature, humidity, weather, population density, floating population, or floating vehicles in the place at which the outdoor display part is installed.

The preference information may be determined according to the number of connections or retrievals of the advertisement data.

Selecting the advertisement data may include reading the advertisement data of a classification group corresponding to the detection signal from the database.

Selecting the advertisement data may include selecting the advertisement data on the basis of the detection signal and time information.

In an embodiment, the method may further include receiving the advertisement data from the internet server and recording the data in the database.

The outdoor display part may be an LCD, an LED, or a PDP.

### BRIEF DESCRIPTION OF THE DRAWINGS

The above and other features of the present invention will be described in reference to certain exemplary embodiments thereof with reference to the attached drawings in which:

FIG. 1 is a block diagram of an outdoor advertisement device in accordance with the present invention;

FIG. 2 is a block diagram of a control server of FIG. 1;

FIG. 3 is a flowchart showing operations of the control server in accordance with the present invention; and

FIG. 4 shows a look-up table of a classified database in accordance with an exemplary embodiment of the present invention.

### DETAILED DESCRIPTION OF EXEMPLARY EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

Throughout this specification, when an element is referred to as “comprises,” “includes,” or “has” a component, it does not preclude another component but may further include the other component unless the context clearly indicates otherwise. Also, as used herein, the terms “ . . . unit,” “ . . . device,” “ . . . module,” etc., denote a unit of processing at least one function or operation, and may be implemented as hardware, software, or combination of hardware and software.

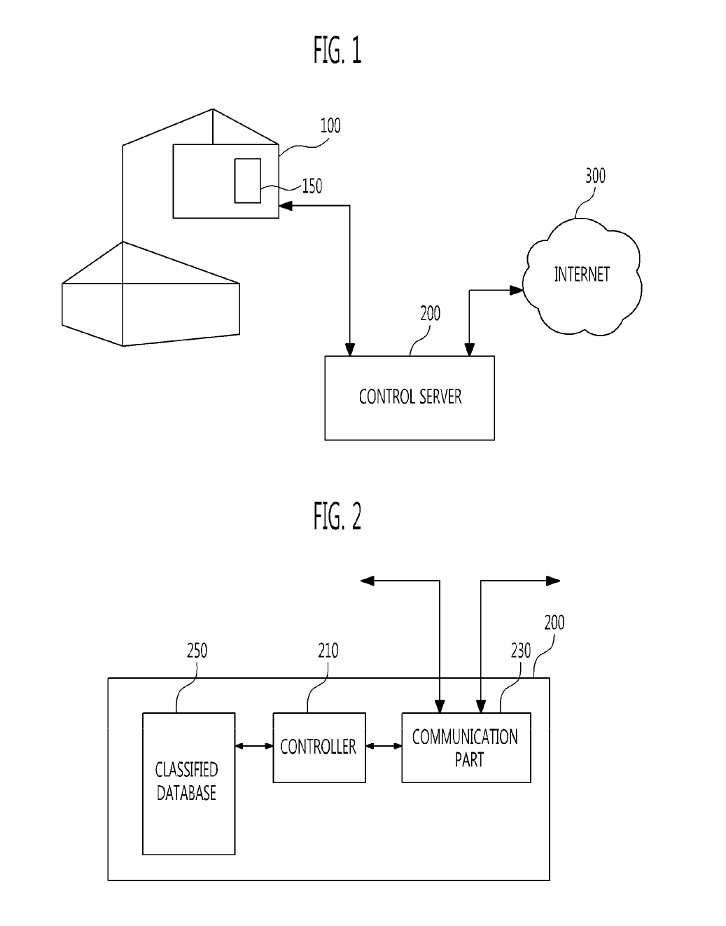

Hereinafter, an outdoor advertisement device in accordance with the present invention will be described with reference to FIGS. 1 and 2.

FIG. 1 is a block diagram of an outdoor advertisement device in accordance with the present invention, and FIG. 2 is a block diagram of a control server of FIG. 1.

Referring to FIG. 1, the outdoor advertisement device in accordance with the present invention includes an outdoor display part 100, a control server 200, and an internet server 300.

The outdoor display part 100 receives predetermined advertisement data from the control server 200 and displays corresponding advertisement data.

The outdoor display part 100 may be a large-sized electronic display such as an LCD, an LED, a PDP, etc., and includes an environment sensor 150.

The environment sensor 150 detects environment information such as a temperature, humidity, rainfall, snowfall, population density, pollution, floating population, floating vehicles, etc., of a place in which the outdoor display part 100 is installed, generates a detection signal, and transmits the detection signal to the control server 200.

The internet server 300 includes a web server such as a portal site, etc., a plurality of advertisement information, and preference information of a user's preference of each advertisement.

The control server 200 is in communication with the outdoor display part 100 and the internet server 300, receives a detection signal of the environment sensor 150 from the outdoor display part 100, and transmits advertisement data corresponding thereto to the outdoor display part 100.

Meanwhile, the control server 200 receives a plurality of advertisement information from the internet server 300, and receives user's preference information of each advertisement.

Referring to FIG. 2, the control server 200 includes a communication part 230, a controller 210, and a classified database 250.

The communication part 230 includes a wireless communication network transmitting/receiving advertisement data and detection signals to/from the outdoor display part 100, and includes a wired/wireless communication network in communication with the internet server 300.

The classified database 250 includes a look-up table in which a plurality of advertisement data are stored and the advertisement data are classified according to classification groups. Each of the classification groups is set to a specific item corresponding to the detection signal.

The advertisement data of the classified database 250 are periodically updated from the internet server 300 via the communication part 230.

The controller 210 receives a detection signal from the outdoor display part 100 via the communication part 230, selects an advertisement to be displayed on the outdoor display part 100 according to advertisement data and preference information from the internet server 300, extracts the advertisement from the classified database 250, and transmits the advertisement to the outdoor display part 100.

Here, the controller 210 selects advertisement data according to the detection signal of the current environment from the outdoor display part 100, and determines order of priority according to preference information, among the selected advertisement data, from the internet server 300. A turnover ratio and a broadcasting order of the advertisement data are determined according to the order of priority to be transmitted to the outdoor display part 100 via the communication part 230.

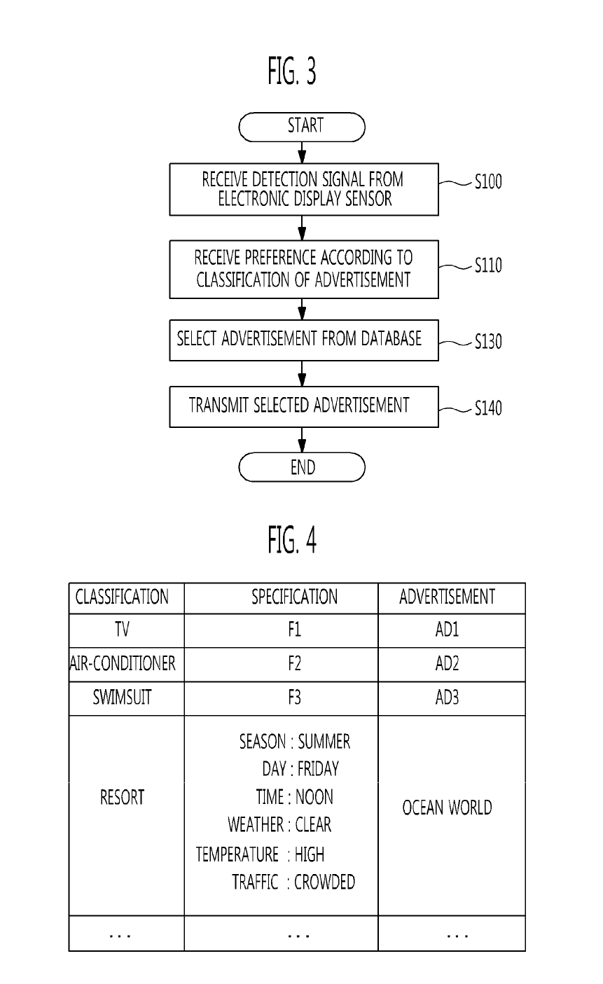

Hereinafter, operations of the control server of FIG. 2 will be described with reference to FIGS. 3 and 4.

FIG. 3 is a flowchart showing operations of the control server in accordance with the present invention, and FIG. 4 shows a look-up table of a classified database in accordance with an exemplary embodiment of the present invention.

As shown in FIG. 3, first, a control server 200 receives a detection signal from an outdoor display part 100 (S100).

The detection signal is transmitted from an environment sensor 150, for example, a temperature sensor, a humidity sensor, a vehicle speed sensor, a population density sensor, etc., included in the outdoor display part 100.

A controller 210 selects a classified group including a corresponding specific item from a look-up table shown in FIG. 4 according to the received detection signal.

For example, when a temperature higher than a predetermined temperature is received as a detection signal, a classified group, in which the high temperature is determined as the specific item, is selected.

When a resort classification is selected as shown in FIG. 4, the control server 200 receives preference of advertisement data included in the resort classification from an internet server (S110).

Preference of the advertisement may be calculated by the number of connections and searches of homepages through sites such as internet portal sites, etc.

When the preference of each advertisement from the internet server is measured, the order of priority of the corresponding advertisement is determined in an order of preference.

The controller 210 reads the advertisement data from the classified database 250, aligns the advertisement data according to the order of priority, determines the number of repetitions and a broadcasting order (S130), and transmits them to the outdoor display part 100 via a communication part 230 (S140).

The outdoor display part 100 displays the advertisement data received from the control server 200 according to the determined priority order.

Meanwhile, a plurality of classifications in which specific items are included with respect to a plurality of detection signals can be selected. In addition, information such as season, day, time, etc., as well as the detection signal, can also be considered together with the specific items.

As described above, it is possible to broadcast appropriate advertisements according to information of the environment in which the outdoor display part 100 is installed, increasing attention of passersby and advertisement effect.

As can be seen from the foregoing, an advertisement can be selected according to peripheral environmental information using sensors installed at an outdoor advertisement device to perform advertisement, increasing attention of passersby, utility of the advertisement, and thus increasing advertisement effect.

It will be apparent to those skilled in the art that the above exemplary embodiments of the present invention may be implemented by a program or a recording medium, in which the program is recorded, configured to perform functions corresponding to the constitution of the embodiments, as well as the device and method disclosed herein.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. An outdoor advertisement device comprising:
an outdoor display part including an environment sensor and displaying transmitted advertisement data; and
a control server for receiving a detection signal from the environment sensor, selecting the advertisement data corresponding to the current environment of a place at which the outdoor display part is installed, and transmitting the advertisement data to the outdoor display part.

2. The outdoor advertisement device according to claim 1, wherein the environment sensor generates the detection signal of information about temperature, humidity, weather, population density, floating population, or floating vehicles in the place at which the outdoor display part is installed.

3. The outdoor advertisement device according to claim 1, further comprising an internet server for transmitting preference information of the advertisement data.

4. The outdoor advertisement device according to claim 3, wherein the control server determines order of priority of the advertisement data according to the detection signal and the preference information of the advertisement data.

5. The outdoor advertisement device according to claim 3, wherein the control server comprises:
a database in which the advertisement data are classified and recorded;
a communication part in communication with the outdoor display part and the internet server; and
a controller for receiving the detection signal from the communication part, receiving the preference information from the internet server, and selecting the advertisement data of the outdoor display part from the database.

6. The outdoor advertisement device according to claim 5, wherein the controller selects the advertisement data on the basis of the detection signal and time information.

7. The outdoor advertisement device according to claim 5, wherein the advertisement data are received from the internet server and recorded in the database.

8. The outdoor advertisement device according to claim 1, wherein the outdoor display part is a liquid crystal display (LCD), a light emitting diode (LED), or a plasma display panel (PDP).

9. An outdoor advertisement method comprising:
receiving a detection signal of current environmental information of a place at which an outdoor display part is installed from an environment sensor of the outdoor display part;
selecting advertisement data corresponding to the detection signal;
receiving preference information of the selected advertisement data from an internet server;
determining order of priority of the advertisement data according to the preference information; and
displaying the advertisement data on the outdoor display part according to the order of priority.

10. The outdoor advertisement method according to claim 9, wherein the environment sensor generates the detection signal of information about temperature, humidity, weather, population density, floating population, or floating vehicles in the place at which the outdoor display part is installed.

11. The outdoor advertisement method according to claim 9, wherein the preference information is determined according to the number of connections or retrievals of the advertisement data.

12. The outdoor advertisement method according to claim 9, wherein selecting the advertisement data includes reading the advertisement data of a classification group corresponding to the detection signal from the database.

13. The outdoor advertisement method according to claim 12, wherein selecting the advertisement data includes selecting the advertisement data on the basis of the detection signal and time information.

14. The outdoor advertisement method according to claim 13, further comprising receiving the advertisement data from the internet server and recording the data in the database.

15. The outdoor advertisement method according to claim 9, wherein the outdoor display part is an LCD, an LED, or a PDP.
